(19) United States
(12) Patent Application Publication
(10) Pub. No.: US 2008/0018067 A1
(43) Pub. Date: Jan. 24, 2008

(54) Device for manually transporting a carcass

(76) Inventor: Alan J. Small, Rifton, NY (US)

Correspondence Address: CHERSKOV and FLAYNIK;Civic Opera Building, Suite 1447, 20 N. Wacker Drive, Chicago, IL, 60606, US

(21) Appl. No.: 11/811,494

(22) Filed: Jun. 11, 2007

Related U.S. Application Data
(63) Continuation-in-part of application No. 11/546,810, filed on Oct. 12, 2006.
Application No. 11/546,810 is a continuation-in-part of application No. 11/398,925, filed on Apr. 6, 2006.

(51) Int. Cl. B62M 11/00

(52) U.S. Cl. 280/19

(57) ABSTRACT

A device 10 for manually transporting a carcass 8 or similar sized object includes a transport member 12, at least one hauling member 18 for manually pulling the transport member 12 with a carcass 8 therein, the hauling member 18 being secured to the transport member 12, at least one carcass member 20 for securing the carcass 8 to the transport member 12, and at least one closing member 22 for wrapping the transport member 12 about the carcass 8

A modified device 200 for hunters to transport a carcass 8 or carry an injured person includes a transport member 12, at least one hauling member 18 for manually hauling the transport member with a carcass 8 therein, the hauling member 18 being secured to the transport member 12, at least one carcass member 20 for securing the carcass 8 to the transport member 12, means for securing the transport member 12 about the carcass 8, and stretcher members 202 for removably receiving lifting members 204, the stretcher members 202 being secured to the transport member 12 such that the transport member 12 and the lifting members 204 cooperate to elevate and support an injured person disposed upon the transport member 12.

A modified device 300 for transporting objects includes a reinforced transport member 302 having cooperating loop and hand members 318 and 320 to promote the manual lifting and carrying of the transport member 302 with an object or injured person wrapped therein to a selected location.

This is a Continuation-In-Part Application of Continuation-In-Part application Ser. No. 11/546,810 filed on Oct. 12, 2006, which is a Continuation-In-Part Application of Parent application Ser. No. 11/398,925, filed on Apr. 6,2006.

### BACKGROUND OF THE INVENTION

1. Field of the Invention

The present invention relates generally to manually dragging or pulling a game carcass from a kill site to a transport vehicle and, more particularly, to hauling a deer carcass over varying terrain without damaging the carcass or straining the back of the person pulling the carcass; and to lifting and carrying an injured person from an injury site to a selected location.

2. Background of the Prior Art

Generally, deer hunters patiently wait upon hunting stands secured in a tree until a deer approaches within a kill range; whereupon, the hunter dispatches the deer, then proceeds to haul the deer carcass to a transport vehicle which may be parked a great distance from the kill site. Occasionally, multiple hunters are spaced over a relatively small area. Two hunters pulling one deer carcass is an optimum method of hauling the carcass over a long distance. However, it is more common for only one person to pull the deer carcass over a trail that includes varying terrains, rocks, brush, weeds, streams and other natural obstacles that can lead to injury to the hunter.

Prior art devices and methods of hauling a deer carcass by one or two persons include wheel carts, hard plastic deer drags, drag harnesses with long leads that wrap around the carcass and allow the carcass to be dragged upon the ground, and drag straps that drag the carcass upon the ground, the drag straps wrapping around a person's waist area or over one shoulder. The problems with the prior art hauling devices is that none entirely encase the carcass to protect the carcass from all natural elements; that the prior art devices do not secure the carcass to the inside of the hauling device or provide a means for adjustably securing the carcass to the inside of the hauling device; that the prior art devices do not secure the hauling device about the carcass after encasing the carcass; and that the prior art devices do not reduce back strain upon and increase the balance of the person pulling the device with the carcass therein.

Also, hunters occasionally are injured to a degree in the field that requires an injured hunter to be carried on a stretcher by other hunters to an aid station. Very few hunting expeditions bring a stretcher to a hunting field. No prior art devices and methods provide a device that can haul a deer and that can be modified to provide a stretcher to lift and carry an injured hunter to an aid station.

Further, steep undulating terrain may be encountered which would prevent the use of a “rigid” stretcher to carry an injured person. A less rigid carrying device is required that encases an injured person therein such that the injured person cannot fall off the carrying device. The less rigid carrying device should include hand grips that prevent the hands of the persons carrying the device from slipping from the device while navigating the undulating terrain, thereby preventing the injured person from hitting the ground. This less rigid device could also be used to carry injured persons from autos or buildings to emergency vehicles; or could be used to enable two persons to carry a myriad of objects from one location to another. No prior art devices or methods provide a flexible carrying device that encases and secures an injured person to the carrying device, while at the same time enhancing the grip of the persons carrying the device while elevating the injured person across sloping terrain.

A need exists for a device that protects the deer carcass while being pulled upon the ground; that reduces the pulling force required to haul the carcass to a transport vehicle; that allows the pulling force to be generated by the hunter's shoulders thereby reducing back strain; that tightly and adjustably cinches the carcass to device; that completely and tightly encases the carcass; that is quickly cleaned and sanitized; and that includes optional features that enable a hunter to carry extra equipment to the hunting site.

Also, a need exists for a device that can be disposed to manually haul or drag a carcass, or that can be disposed to manually lift and carry an injured hunter. Further, a need exists for a flexible device that can be used to carry an injured person across varying terrain such that the injured person remains totally encased within the device so as to not fall from the device irrespective of the positions of the persons carrying the device when walking upon sloping ground.

### SUMMARY OF THE INVENTION

It is a principle object of the present invention is to provide a device for manually transporting a carcass or object. A feature of the device is a transport member that is water and tear resistant. An advantage of the device is that a deer or similarly sized animal carcass is wrapped about by the transport member, then manually dragged by a person over varying terrain until reaching a transport vehicle. Another advantage of the device is that the transport member is quickly cleaned and disinfected with liquid compounds after removing the carcass.

Another object of the present invention is to provide a device that allows a person to manually pull the device with a relatively large carcass wrapped therein. A feature of the device is a hauling member or strap assembly that protrudes from a front end of the transport member and is sufficiently secured to the transport member to allow a relatively heavy carcass to be pulled over varying terrain without deforming the straps or transport member. An advantage of the device is that the straps will not tear from the transport member. Another advantage of the device is that the straps can be grasped by a person to allow the person to pull the device and the carcass without straining his or her back. Still another advantage of the device is that the straps can be secured to a safety harness which is cooperatively secured to a person who will pull the device and the carcass therein, the safety harness directing dragging forces away from his or her back thereby avoiding back strain and loss of balance.

Still another object of the present invention is to provide a device that secures the carcass to a carcass engagement side of the transport member. A feature of the device is a carcass member that includes at least one and preferably three non-deformable strap and fastener assemblies that tightly and quickly cinch the carcass to the carcass engagement side of the transport member. An advantage of the device is that the straps are sufficiently long and the fasteners adjustable to promote the securing of varying sized carcasses to the transport member. Another advantage of the device is that the straps and fasteners are sufficient in quantity to engage portions of the carcass that prevent the carcass from sliding out a rear end of the transport member while a person pulls the device and carcass across varying terrains. Still another advantage of the device is that the fasteners are quickly joined together and quickly separated via manual manipulation.

Yet another object of the present invention is to provide a device that adjusts the position of strap and fastener assemblies. A feature of the device is first and second adhesive members permanently joined to preselected ends of the straps and predetermined portions of the transport member, respectively. Another feature of the device is a grasping member secured to the first adhesive member. An advantage of the device is that the securing forces generated by the cinched straps are focused upon portions of the carcass that promote the retention of the carcass within the transport member while the transport member is manually pulled over varying terrain. Another advantage of the device is that the first and second adhesive members are quickly separated via the grasping member thereby allowing a person to quickly adjust the focus positions of the forces generated by the cinched straps.

Another object of the present invention is to provide a device that secures the transport member about the carcass. A feature of the device is a closing member that includes at least one and preferably three non-deformable strap and fastener assemblies that tightly and quickly cinch the transport member about the carcass after wrapping the transport member about the carcass. An advantage of the device is that the straps are sufficiently long and the fasteners adjustable to promote the securing of the transport member about varying sized carcasses. Another advantage of the device is that the straps and fasteners are sufficient in quantity to engage portions of the carcass that prevent the carcass from sliding out the rear end of the transport member while a person pulls the device and carcass across varying terrains. Still another advantage of the device is that the fasteners are quickly joined together and quickly separated via manual manipulation. Yet another advantage of the device is that the position of the straps and fasteners of the closing member are adjustable via the same first and second adhesive members utilized with the carcass member described above; adjusting the position of the straps and fasteners promotes focused securing forces generated by the cinched straps upon portions of the carcass thereby retaining the carcass inside the transport member while being manually pulled over varying terrain.

Still another object of the present invention is to provide a device for hunters to transport a carcass or carry an injured person. A feature of the device is a plurality of stretcher members secured to the transport member. Another feature of the device is a pair of lifting members removably inserted into said stretcher members. An advantage of the device is that the stretcher members and the lifting members cooperate to elevate and support the transport member with an injured hunter thereupon. Another advantage of the device is that the transport member is ultimately disposed to manually transport a carcass or to manually carry an injured person to a selected location.

Another object of the present invention is to provide a device and method for two or more persons to transport an injured person across undulating terrain without the injured person falling from the device. A feature of the device is a deformable or flexible transport member that encases an injured person and secures the injured person to the transport member. Another feature of the device is detachable handles that promote the grasping and carrying of the transport member over the undulating terrain, irrespective of the configuration of the transport member or the positioning of the persons carrying the transport member over the undulating terrain. An advantage of the device is that the transport member remains wrapped around the injured person irrespective of the orientation of the above the undulating terrain, thereby preventing the injured person from falling from or rolling off the device. Another advantage of the device is that two or more persons are enabled from multiple lifting points to elevate and carry the transport member while wrapped about the injured person.

Briefly, the invention provides a device for manually transporting a carcass comprising a transport member having a ground engagement side and a carcass engagement side; at least one hauling member for manually pulling said transport member with a carcass therein, said hauling member being secured to said transport member; at least one carcass member for securing the carcass to said transport member, said carcass member being secured to said transport member; and at least one closing member for encasing the carcass within said transport member, said closing member being secured to said transport member.

The invention further provides a hunting device for transporting game comprising a carcass encasement member; means for manually pulling said carcass encasement member with a carcass disposed therein over varying terrain; means for adjustably securing the carcass to one side of the carcass encasement member; means for promoting the encasement of the carcass by said carcass encasement member; and means for maintaining said carcass encasement member about the carcass.

The invention further provides a method for manually transporting an object, said method comprising the steps of providing an encasing member; providing means for manually pulling said encasing member; adjustably securing said object to said encasing member; wrapping said encasing member about the object; and maintaining the wrap position of said encasing member about the object.

Also, the invention provides a device for hunters to transport a carcass or carry an injured person comprising a transport member; at least one hauling member for manually pulling said transport member with a carcass therein, said hauling member being secured to said transport member; at least one carcass member for securing the carcass to said transport member, said carcass member being secured to said transport member; means for securing said transport member about the carcass; and stretcher members for removably receiving lifting members, said stretcher members being secured to said transport member such that said transport member and said lifting members cooperate to elevate and support an injured person disposed upon said transport member, whereby said transport member is ultimately disposed to manually transport a carcass or to manually carry an injured person to a selected location.

The invention further provides a hunting device for transporting objects comprising an encasement member; means for manually pulling said encasement member with a carcass disposed therein over varying terrain; means for securing the carcass to said encasement member; means for maintaining said encasement member about the carcass; and means for converting said encasement member into a stretcher to promote the manually lifting and carrying of said encasement member with a person disposed thereupon.

The invention further provides a method for manually transporting an object or a person, said method comprising the steps of providing a transport member; providing means for manually pulling said transport member; providing means for securing an object to said transport member; providing means for securing said transport member about the object; providing means for manually lifting and carrying said transport member with a person thereupon; and adapting said transport member for manually transporting an object or a person.

The invention further provides a device for manually transporting an object comprising a transport member; at least one hauling member for manually lifting a front portion of said transport member with an object therein, said hauling member being secured to said transport member; at least one securing member for securing the object to said transport member, said securing member being attached to said transport member; means for manually elevating a portion of said transport member distal to said hauling member; and means for securing said transport member about the object, whereby said hauling member and said manual elevating means promote the manual transport of the object disposed upon said transport member to a selected location.

The invention further provides a manual transport device comprising an encasement member; means for manually lifting and carrying said encasement member with an object disposed therein; means for securing the object to said encasement member; means for maintaining said encasement member about the object; and means for converting said encasement member into a stretcher to promote the manual lifting and carrying of said encasement member with a person disposed thereupon.

The invention further provides a method for manually transporting an object or a person, said method comprising the steps of providing a transport member; providing means for manually elevating a front end of said transport member; providing means for manually elevating a rear end of said transport member; securing an object or a person to said transport member; securing said transport member about the object or the person; manually grasping said means for manually elevating a front end of said transport member; and manually grasping said means for manually elevating said rear end of said transport member, whereby the object or person is manually elevated and transported to a selected location without damage or injury to the object or person.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a top elevation-phantom view of a device for manually transporting a carcass or object in accordance with the present invention.

FIG. 2 is a bottom elevation-phantom view of the device of FIG. 1.

FIG. 3 is a top elevation view of the device of FIG. 1, but with adjustable securing means depicted in accordance with the present invention.

FIG. 4 is a perspective-exploded view of the device of FIG. 3 in accordance with the present invention.

FIG. 5 is a perspective view of the device of FIG. 3, but with the device rotated 180 degrees and with a deer carcass thereupon in accordance with the present invention.

FIG. 6 is a perspective view of the device and deer of FIG. 5, but with one carcass member securing the front legs and a portion of the body of the deer to a transport member.

FIG. 7 is a perspective view of the device and deer of FIG. 6, but with one carcass member securing the front legs and a portion of the body of the deer to the transport member, and a second carcass member securing a second portion of the body of the deer to the transport member.

FIG. 8 is a perspective view of the device and deer of FIG. 7, but with one carcass member securing the front legs and a portion of the body of the deer to the transport member, a second carcass member securing a second portion of the body of the deer to the transport member, and a third carcass member securing the rear legs and a third portion of the body of the deer to the transport member.

FIG. 9 is a perspective view of the device and deer of FIG. 8, but with one closing member securing a rear portion of the transport member about a rear portion of the deer.

FIG. 10 is a perspective view of the device and deer of FIG. 9, but with two closing members securing rear and mid-portions of the transport member about rear and mid-portions of the deer.

FIG. 11 is a perspective view of the device and deer of FIG. 10, but with three closing members securing rear, mid and front portions of the transport member about rear, mid and front portions of the deer.

FIG. 12 is a perspective view of the transport member encasing the deer, and of the hunter pulling the transport member via hauling members in accordance with the present invention.

FIG. 13 is a perspective view of the transport member encasing the deer, and of the hunter pulling the transport member via a harness detachably secured to the hauling members in accordance with the present invention.

FIG. 14 is a phantom front perspective view of an optional pouch for containing a field dressing kit and cleaning supplies in accordance with the present invention.

FIG. 15 is a phantom side perspective view of the pouch of FIG. 14.

FIG. 16 is a phantom back perspective view of the pouch of FIG. 14.

FIG. 17 is a perspective view of an optional carrying case for transporting the device in accordance with the present invention.

FIG. 18 is a perspective view of a modified device for hunters to transport a carcass or carry an injured person with detachable carcass members secured to a transport member in accordance with the present invention.

FIG. 19 is a perspective view of the modified device of FIG. 18, but with the detachable carcass members removed in accordance with the present invention.

FIG. 20 is a perspective view a sling member in accordance with the present invention.

FIG. 21 is a perspective view of the sling member of FIG. 20 with detachable carcass members inserted through cooperating portions of the sling member in accordance with the present invention.

FIG. 22 is a perspective view of the sling member in an open position with an upper end detachably secured to the transport member via a carcass member in accordance with the present invention.

FIG. 23 is a perspective view of the sling member of FIG. 22, but in a folded position with upper and lower ends, and a mid-portion detachably secured to the transport member via carcass members in accordance with the present invention.

FIG. 24 is a perspective view of the modified device of FIG. 18, but with one lifting member inserted through stretcher members secured to a first edge of the transport member in accordance with the present invention.

FIG. 25 is a perspective view of the modified device of FIG. 18, but in an elevated position with the first straps of carcass members secured to the second straps of the closing members, and with the detachable second straps of the carcass members removed from the transport member in accordance with the present invention.

FIG. 26 is a top elevation view of a modified transport member of the device of FIG. 18 in accordance with the present invention.

FIG. 27 is a bottom elevation view of a first portion of a securing member in accordance with the present invention.

FIG. 28 is a bottom elevation view of a second portion of a securing member in accordance with the present invention.

FIG. 29 is a top elevation view of a hand member in accordance with the present invention.

FIG. 30 is a top perspective view of a first portion of the hand member of FIG. 29 being manually inserted through a loop member secured to a rear end of a transport member in accordance with the present invention.

FIG. 31 is a perspective view of the first portion of FIG. 30 depicting the first portion being manually folded such that first and second adhesive members secured to the top of the first portion are joined together to detachably secure the hand member to the transport member in accordance with the present invention.

FIG. 32 is perspective view of a person manually elevating a rear portion of the transport member via a second portion of the hand member wrapped about the wrist of the person while the person's hands grasp the second portion of the hand member in accordance with the present invention.

FIG. 33 is a perspective view of the device being carried by one person grasping hauling members secured to the front end of the transport member, and a second person grasping hand members secured to the rear end of the transport member in accordance with the present invention.

### DESCRIPTION OF THE PREFERRED EMBODIMENT

Referring now to the drawings, a device for manually transporting a carcass 8 or similar sized object in accordance with the present invention is denoted by numeral 10. The device 10 includes a transport member 12 having a ground engagement side 14 and a carcass engagement side 16, at least one hauling member 18 for manually hauling the transport member 12 with a carcass 8 therein, said hauling member 18 being secured to the transport member 12, at least one carcass member 20 for securing the carcass 8 to the transport member 12, the carcass member 20 being secured to the transport member 12, and at least one closing member 22 for encasing the carcass 8 within the transport member 12, the closing member 22 being secured to the transport member 12. An optional carrying case 23 may be utilized to facilitate the storage and transport of the device 10 to the carcass site, whereupon, the transport member 12 is deployed to encase the carcass 8.

The transport member 12 is relatively lightweight and fabricated from a nylon reinforced vinyl coated material or similar tear resistant, water repellent material with a bright color such as orange to announce the presence of the person pulling the transport member 12 to other hunters. The transport member has a relatively tear resistant ground engagement side 14 and a relatively smooth carcass engagement side 16. The ground engagement side 14 is capable of being pulled over rocks, weeds and bare ground without tearing. The carcass engagement side 16 is sufficiently rugged to engage and transport a relatively large animal such as a deer without tearing, and sufficiently smooth to promote the removal of blood, dirt and weeds by simply applying water or similar cleaning fluid to the material. The transport member 12 includes a peripheral stitching 13 that binds a folded edge of the transport member 12 to provide a finished periphery that prevents shredding and/or unraveling of cut edges of the transport member 12.

A pouch or similar storage compartment 24 is optionally attached to the transport member 12 or carrying case 23 for storing items including but not limited to gloves, cleaning materials including a container of water or disinfectant liquid, carcass organ storage bags, tag ties and writing materials. The pouch 24 may be permanently or detachably secured to the transport member 12 or carrying case 23 via stitching or a hook and loop adhesive material 27 such as Velcro. The transport member 12 includes a substantially rectangular configuration sized to receive a carcass thereupon such that the carcass is totally disposed upon the carcass engagement side 16 without any extremity extending beyond the periphery of the transport member 12. In the event that a relatively large carcass 8 is wrapped in the transport member 12 such that rear legs extend beyond a rear end 25 of the transport member 12, the carcass 8 would be sufficiently secured inside the transport member 12 such that the transport member 12 and rear legs extending therefrom would be movable by a person pulling the transport member 12 via the hauling member 18. Although intended for transporting the carcass 8 of hunted game, the device 10 may be used to manually transport a myriad of objects including but not limited to trees and shrubs, furniture, large fish, injured persons and camping equipment.

The hauling member 18 includes at least one and preferably first and second outer straps 26 and 28, and middle strap 30 fabricated from polypropylene or similar material that is woven into a webbed configuration that is light weight and extremely resistant to stretching and breakage. The first and second straps are relatively long and wide strips of polypropylene that include a long portion 32 that is secured to the carcass engagement side 16 of the transport member 12, and a short portion 34 that is secured to the ground engagement side 14 thereby forming loops that a person grasps via one hand or two to pull the transport member 12 and the carcass 8 wrapped within thereby reducing back strain when transporting a carcass over varying landscapes. The straps 26 and 28 are secured to the transport member 12 via stitching or similar permanent attachment means. The length and width of the straps 26 and 28 promote sufficient surface area to attach the straps 26 and 26 to the transport member 12 such that a heavy carcass 8 is capable of being dragged across hostile terrain without tearing the straps 26 and 28 from transport member 12. Further, the long portion 32 provides a continuous surface to which a plurality of carcass members may be fixedly or adjustably attached; and the short portion 34, which can extend a longitudinal length equal to that of the long portion 32, provides a continuous surface to which a plurality of closing members may be fixedly or adjustably attached. The first and second straps 26 and 28 allow one or two individuals to pull the device by combining or separating the straps when pulling the transport member 12.

The middle strap 30 is an optional feature of the device 10. The middle strap 30 is required when only one person is available to pull the device 10, and the head of a relatively large animal requires extra support at the front end 35 of the transport member 12. A single person pulling the device 10 would gather together all three straps 26, 28 and 30, then pull the device 10 with the carcass therein, via hand, or by clipping the three straps to a tree stand safety harness or drag harness which secured to the individual's shoulders thereby allowing his or her arms and hands free to carry a weapon or other equipment. Alternatively, two persons would each grab one strap 26 and 28, then cooperatively pull the transport member 12 and the carcass 8 wrapped therein to a transport vehicle (not depicted).

The carcass member 20 includes one or more and preferably three adjustable strap assemblies 20 fabricated from the same webbed material as the hauling member 18, but with relatively shorter lengths and widths. The strap assemblies 20 are sufficiently long to extend over the carcass 8 or object placed upon the transport member 12, and continuing in length to promote the binding of corresponding front or back legs of a deer carcass 8. The width of the strap assemblies 20 is smaller than the width of the hauling member 18 due to function of the strap assemblies 20 being retention of the carcass 8 in the transport member 12 rather than pulling the transport member. Each strap assembly 20 includes a first strap 36 having a first end 38 secured to the transport member 12 proximate to a first longitudinal edge 40 of the transport member 12. The preferred attachment location for the first end 38 to the transport member 12 is upon the long portion of the first outer strap 26 thereby reducing the risk of tearing the transport member 12 when the first strap 36 is drawn taught to ultimately secure the carcass 8 to the transport member 12. The first strap 36 has a second end 42 adjustably secured to a first end 44 of a first portion 46 of a fastener member 48 such that the first portion 46 of the fastener member 48 is slidably positioned across the first strap 36. The fastener 48 is a model Fastex SR1, manufactured by ITW Nexus of Wood Dale, Ill. 60191. The fastener 48 is protected by U.S. Pat. Nos. 4,150,464 and 4,171,555. Although straps and fasteners are the preferred elements for securing the carcass 8 to the transport member 12, alternative securing assembles that include snaps, hooks, clamps and deformable materials may substitute for the strap assemblies 20.

Each carcass member or strap assembly 20 further includes a second strap 50 having a first end 52 secured to the transport member 12 proximate a second longitudinal edge 54 of the transport member 12. The preferred attachment location for the first end 52 to the transport member 12 is upon the long portion of the second outer strap 28, further reducing the risk of tearing the transport member 12 when the first strap 36 is drawn or cinched tight to secure the carcass 8 to the carcass engagement side 16 of the transport member 12. The second strap 50 has a second end 56 secured to a first end 58 of a second portion 60 of the fastener member 48. The first and second portions 46 and 60 of the fastener member 48 have cooperating second ends 62 that detachably join such that a carcass 8 is ultimately secured to the transport member 12 via the second end 42 of the first strap 36 after the second end 42 is forcibly and distally pulled by the hunter from joined second ends 62 of the first and second portions 46 and 60 of the fastener member 12. The second end 62 of the first portion 46 of the fastener member 48 includes means for manually releasing (physically “squeezing” outer portions of the second end 62 of the first portion 46 inwardly via outer side recesses in the second portion 60) the first portion 46 of the fastener member 48 from the second portion 60 of the fastener member 48 thereby allowing the first and second portions 46 and 60 to be manually separated to promote the removal of the carcass 8 from the transport member 12.

The closing member 22 includes one or more and preferably three adjustable strap assemblies 22 fabricated from the same material as the hauling member 18, and with substantially the same dimensions as the carcass member 20. Each strap assembly 22 includes a webbing strap 70 having a first end 72 secured to the transport member 12 proximate to the first longitudinal edge 40 of the transport member 12. The first strap 70 has a second end 74 adjustably secured to a first end 76 of a first portion 78 of a fastener member 80 such that the first portion 78 of the fastener member 80 is slidably positioned across the first strap 70. The fastener 80 is the same model and manufacture as the fastener 48 for the carcass member 20 discussed supra. Further, the substitute carcass member assemblies (hooks, clamps, etc.) discussed supra, may be used for the closing members 22.

Each strap assembly 22 further includes a second strap 82 having a first end 84 secured to the transport member 12 proximate the second longitudinal edge 54 of the transport member 12. The second strap 82 has a second end 86 secured to a first end 88 of a second portion 90 of the fastener member 80. The first and second portions 78 and 90 of the fastener member 80 have cooperating second ends 92 that detachably join such that a carcass 8 is ultimately encased within the transport member 12 via the second end 74 of the first strap 70 being forcibly and distally moved by the hunter from joined second ends 92 of the first and second portions 78 and 90 of the fastener member 80. The second end 92 of the first portion 78 of the fastener member 80 includes means for manually releasing (physically squeezing outer portions of the second end 92 of the first portion 78 inwardly via outer side recesses in the second portion 90) the first portion 78 of the fastener member 80 from the second portion 90 of the fastener member 80 thereby allowing the first and second portions 78 and 90 to be manually separated to promote the separation of the first and second longitudinal edges 40 and 54 of the transport member 12 to expose the carcass 8 secured therein.

A feature of the device 10 is to totally encase or wrap the carcass 8 with the transport member 12 after securing the carcass 8 to the carcass engagement side 16 of the transport member 12. To achieve this feature, the long portion 32 of the first outer strap 26 is secured to the carcass engagement side 16 of the transport member 12. The long portion 32 is then separated from the first longitudinal edge 40 of the transport member 12 a distance greater than the distance separating the short portion 34 of the first outer strap 26 from the first longitudinal edge 40, the short portion 34 being secured to the ground engagement side 14 of the transport member 12. The first ends 38 of one or more (preferably three) first straps 36 of the carcass member 20 are spaced upon and secured to the long portion 32 of the first outer strap 26, and the first ends 72 of one or more (preferably three) first straps 70 of the closing member 22 are spaced upon and secured to the short portion 34 of the first outer strap 26 and the ground engagement side 14.

Further, to achieve the total encasement of the device about the carcass 8, the long portion 32 of the second outer strap 28 is secured to the carcass engagement side 16 of the transport member 12. The long portion 32 is then separated from the second longitudinal edge 54 of the transport member 12 a distance greater than the distance separating the short portion 34 of the second outer strap 28 from the second longitudinal edge 54, the short portion 34 being secured to the ground engagement side 14 of the transport member 12. The first ends 52 of the second straps 50 of the carcass member 20 are spaced upon and secured to the long portion 32 of the second outer strap 28, and the first ends 84 of the second straps 82 of the closing member 22 are spaced upon and secured to the short portion 34 of the second outer strap 28.

After cinching the carcass 8 tightly to the transport member 14 via the carcass member 22, the distances separating respective long and short portions 32 and 34 of the first and second outer straps 26 and 28, allow the first and second longitudinal edges 40 and 54 and cooperating portions of the transport member 12 to overlap thereby encasing or wrapping the carcass 8. The second ends 92 of the first and second portions 78 and 90 of the closing fastener member 80 are then detachably joined, and the second ends 74 of the first straps 70 are pulled to tightly cinch the transport member 12 about the carcass 8.

A carcass 8 or other objects transported by the device 10 may include configurations that the carcass member 20 cannot tightly secure to the transport member 12 due to the fixed positions of the first ends 38 and 52 of respective first and second webbing straps 36 and 50 of the carcass member 20. A carcass 8 or object not tightly secured to the transport member 12 will ultimately slide from the wrapped transport member 12 via the rear end 25. To facilitate the use of the device 10 to transport a carcass 8 or object with an unconventional configuration, means for adjustably securing the first end 52 of the second strap 50 to the transport member 12 are provided.

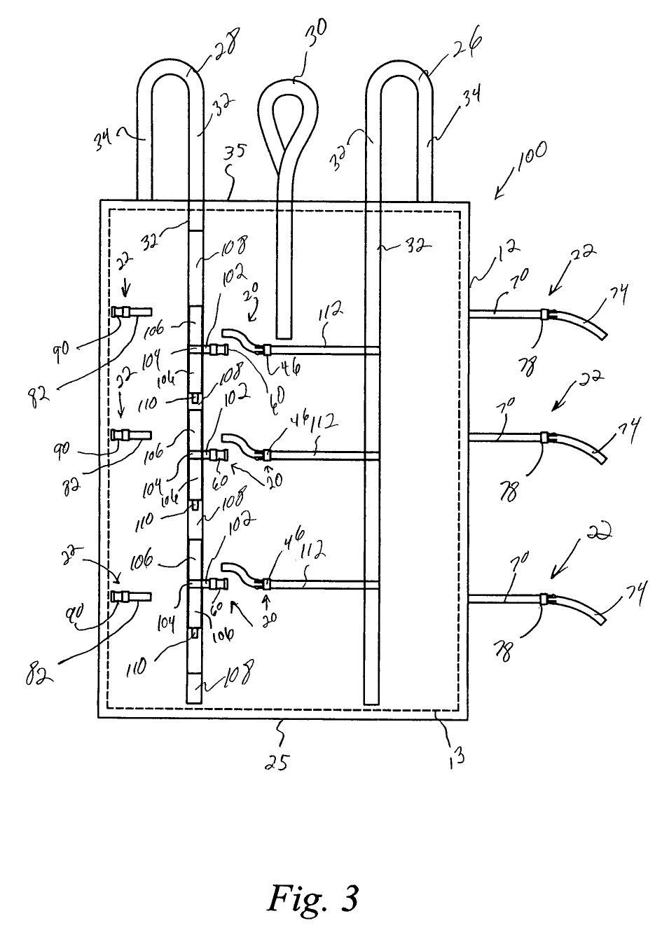

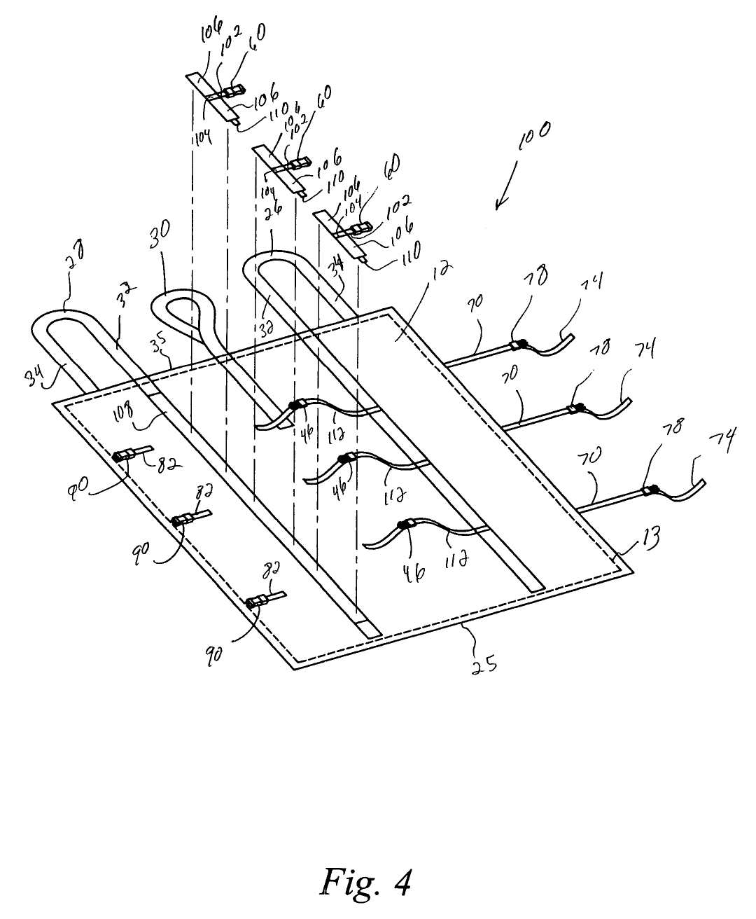

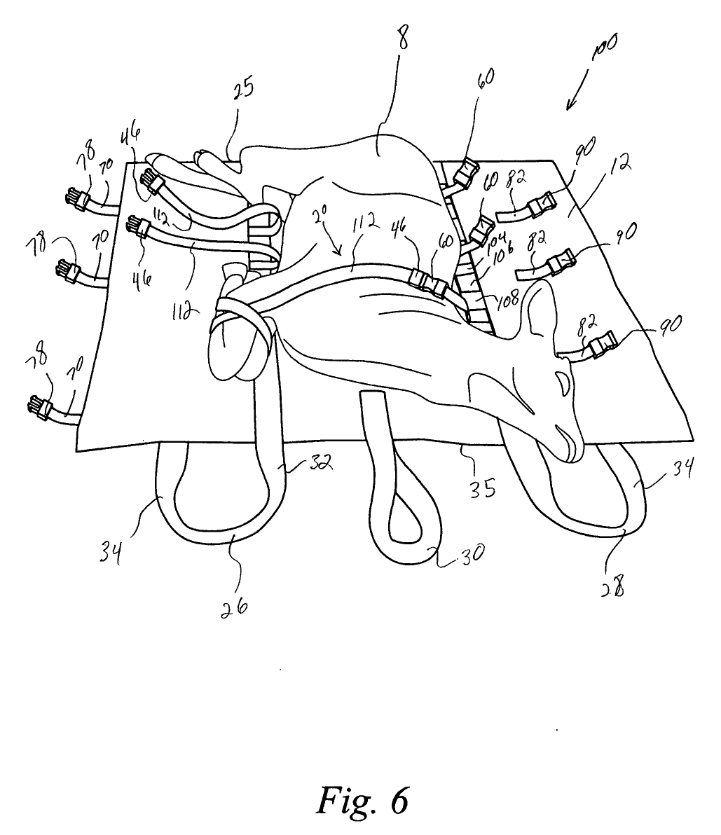

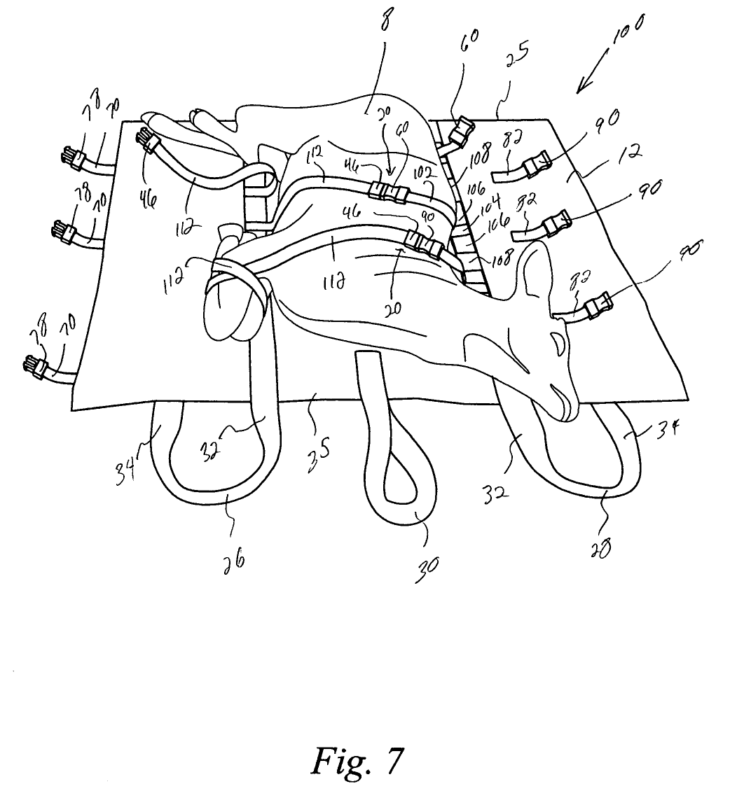

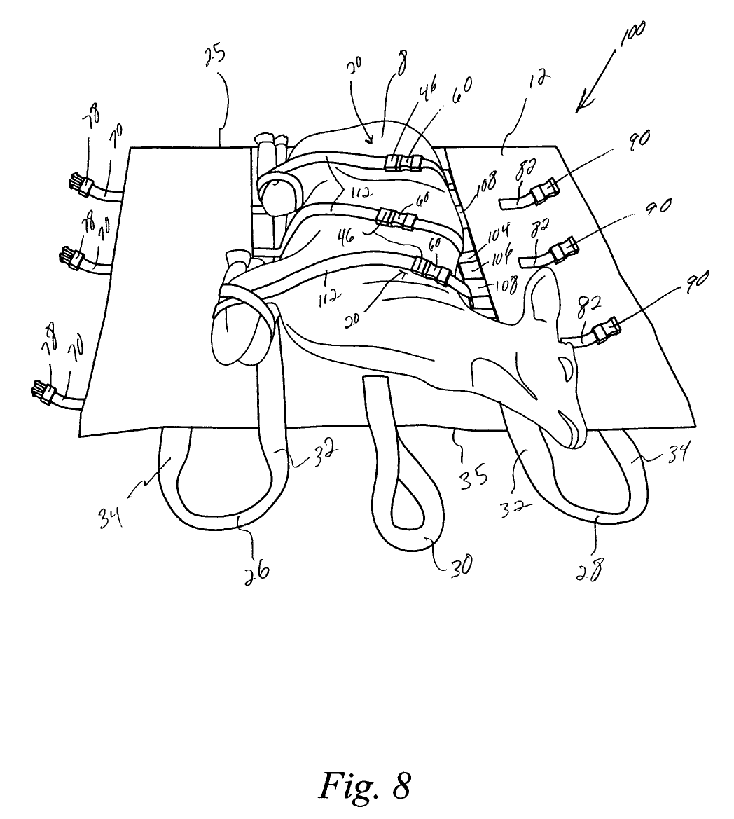

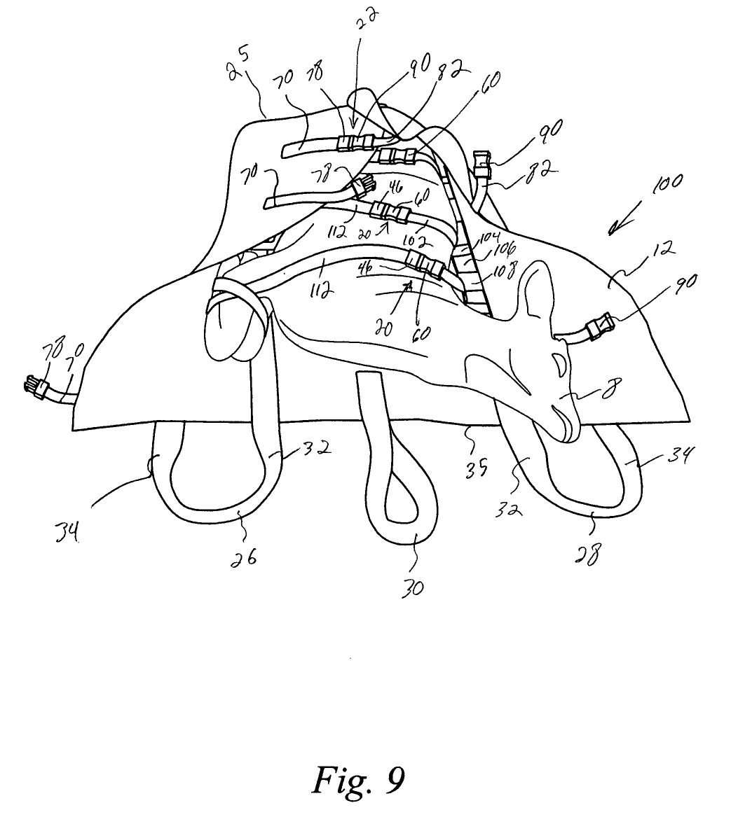

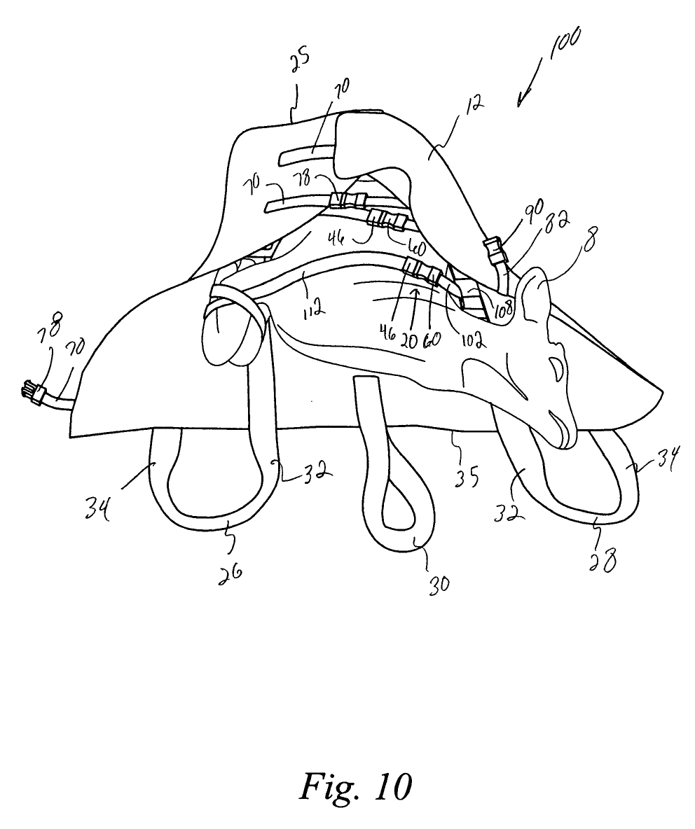

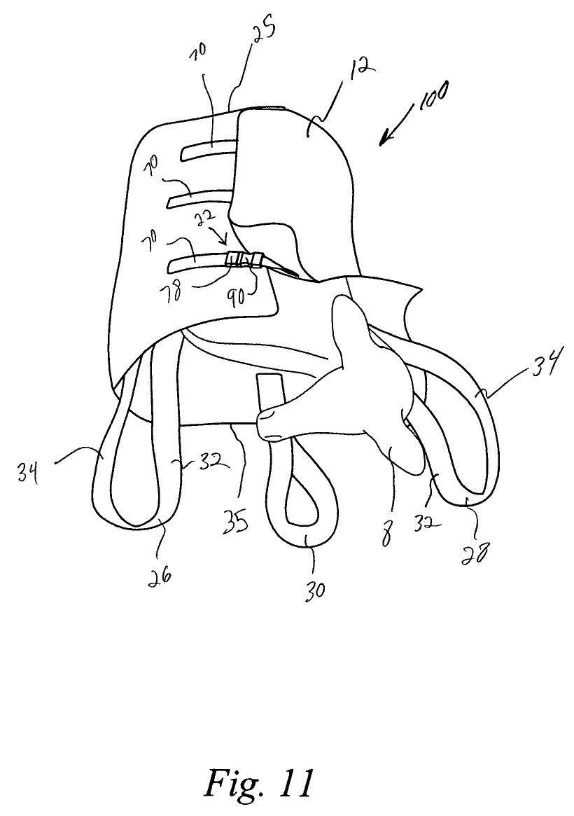

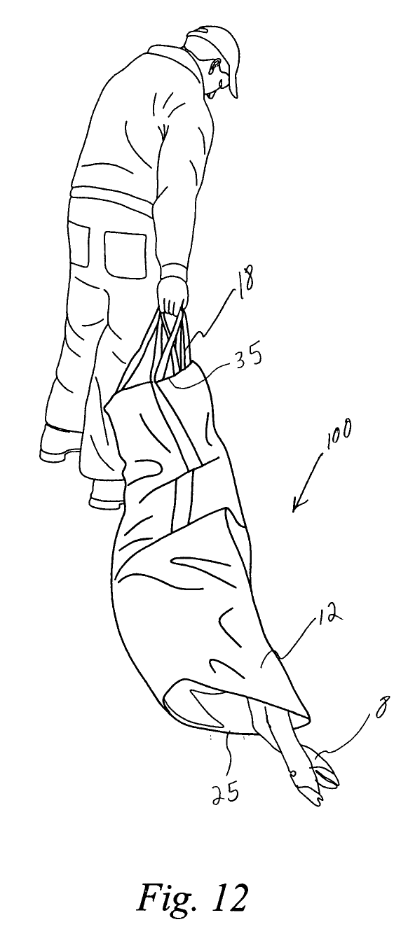

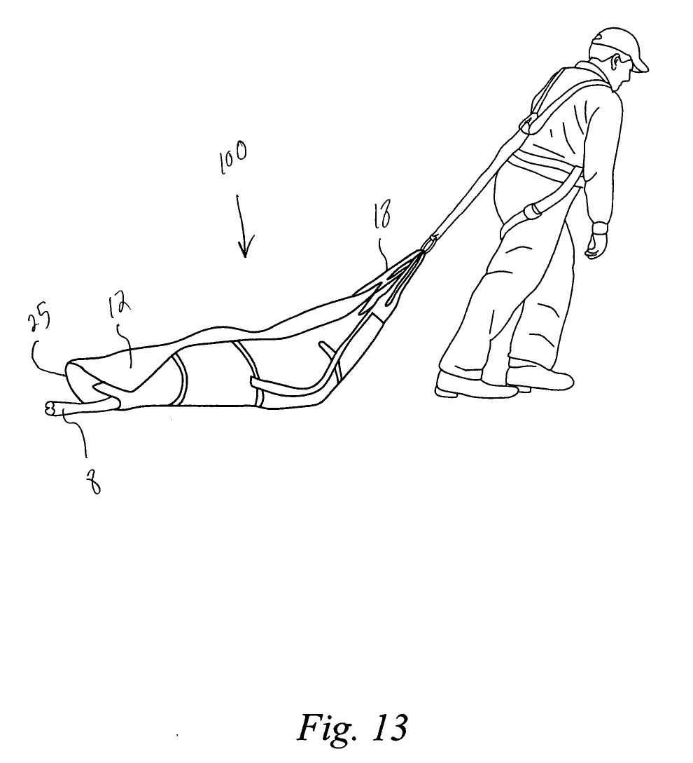

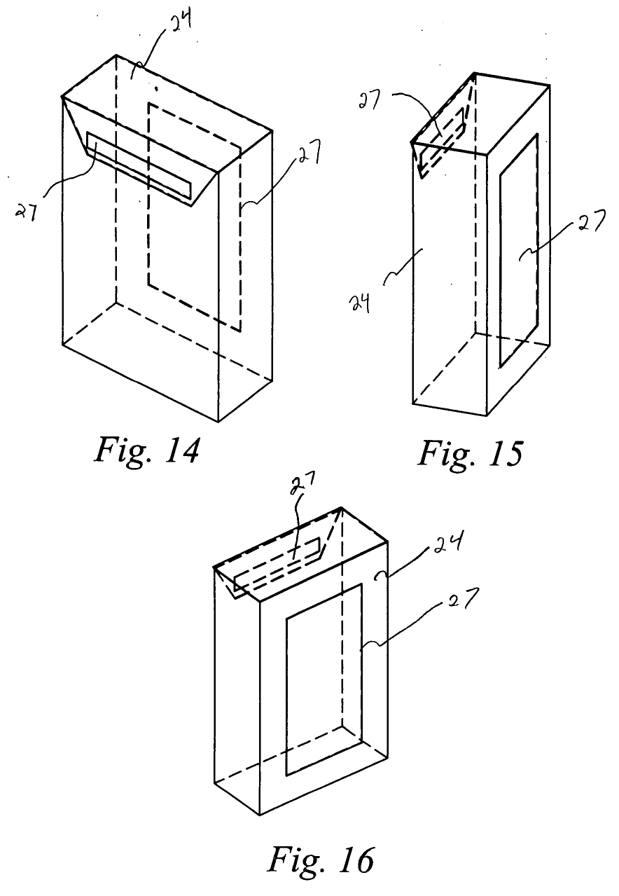

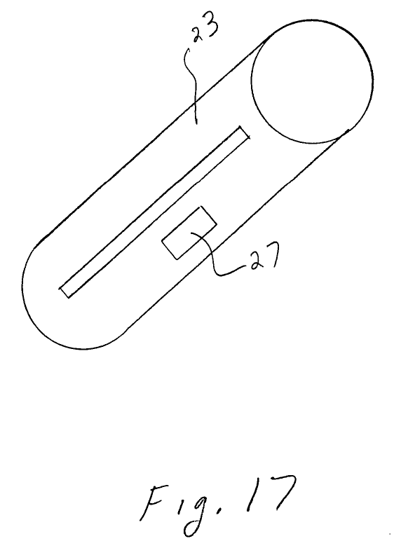

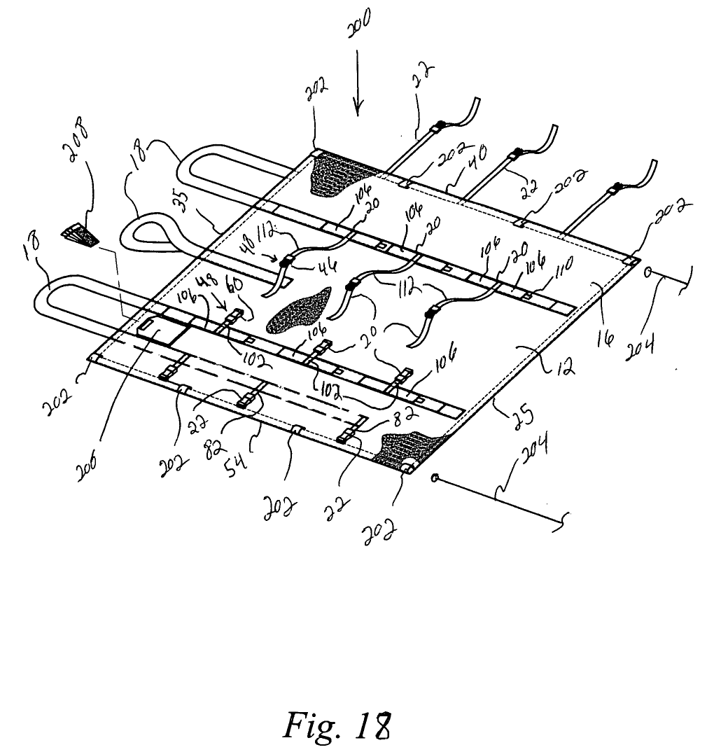

Referring now to FIGS. 3-13, an alternative device 100 is depicted with carcass second straps 102 that include first ends 104 secured to first adhesive members 106, and a second adhesive member 108 completely covering and secured to the long portion 32 of the second outer strap 28. The first adhesive members 106 are fabricated from a hook material, and the second adhesive member 108 is fabricated from a loop material. Typically, both hook and loop materials are included in Velcro®, a well know adhesive material. The first adhesive member 106 includes a grasping member 110 for promoting the manual separation of the first adhesive member 106 from the second adhesive member 108, thereby facilitating the re-use of the device when varying the size of the carcass or object to be transported by the device 100. The first adhesive members 106 are dimensioned to congruently engage a cooperating portion of the second adhesive member 108 such that the carcass 8 or object encased by the transport member 12 is tightly secured therein. The larger and/or heavier the carcass 8 or object, the longer the longitudinal dimension of the first adhesive members 106 to maintain engagement with the second adhesive member 108 when manually pulling the device 10. However, the longitudinal dimension of the first adhesive members 106 is limited by the longitudinal dimension of the long portion 32 of the second outer strap 28. To tightly secure the carcass 8 or object having an unconventional configuration, more first and second straps 112 and 102 (more than three) may be required tightly secure the carcass 8 or object to the transport member 12.

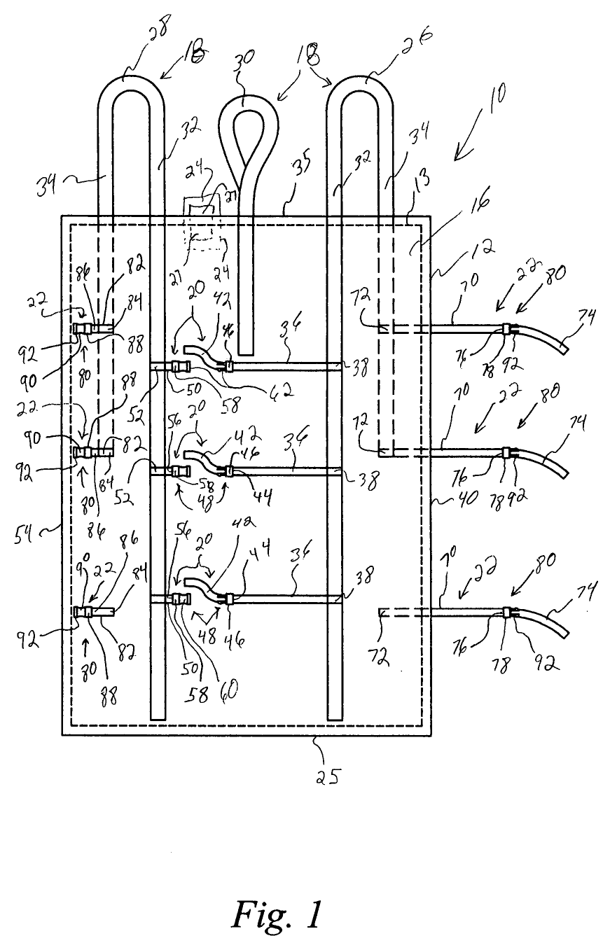

Utilizing adhesive members 106 and 108 for the first ends 104 of the second straps 102 with a uniquely configured carcass 8 or object may result in the first and second straps 112 and 102 forming an acute angle with the long portions 32 of the first and second outer straps 26 and 28, instead of the typical right angle. Varying from the right angle orientation can reduce the “grasp” of the straps 112 and 102 upon the carcass 8. To prevent the acute angle orientation, the adjustable securing means discussed above for the first ends 104 of the second straps 102, can be included (although not depicted) with the first ends 38 (see FIG. 1) of the first straps 36 of the carcass member 20. Further, the adjustable securing means discussed above may be included with the first ends 72 and 84 of respective first and second straps 70 and 82 of the closing member 22, thereby promoting a tight encasement of transport member 12 about the unconventionally configured carcass 8 or object.

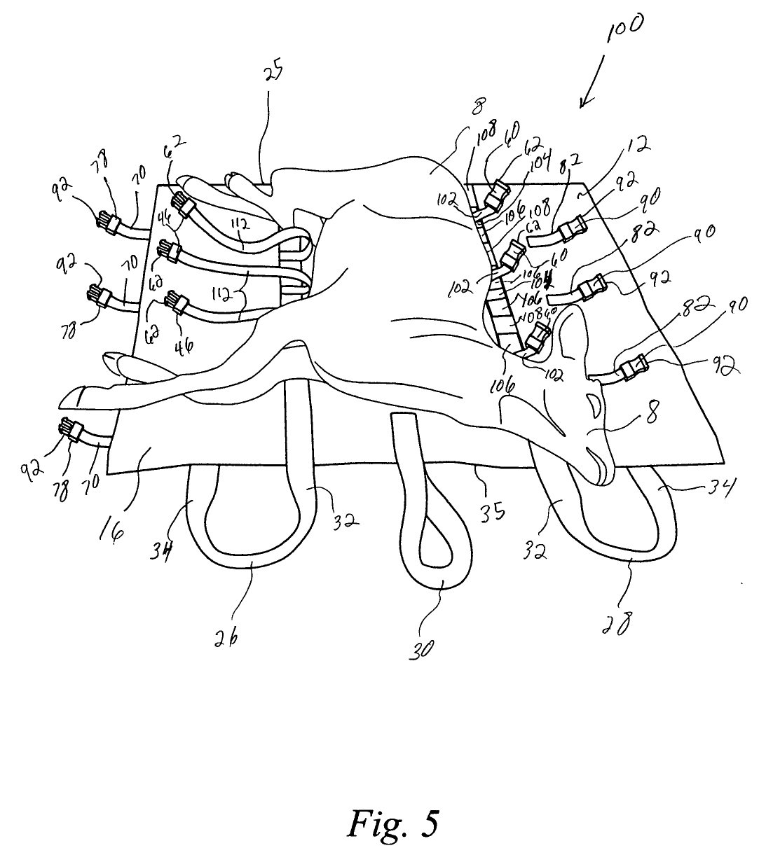

In operation, a substantially rectangular configured transport member 12 fabricated from nylon reinforced vinyl coated, or similar impervious “tough” material is dimensioned to completely wrap or encase a preselected animal carcass 8 or object. One or more carcass members 20 for securing the carcass 8 to the transport member 12 are comprised of first and second straps 36 and 50 fabricated from non-deformable material such as a webbing material, and fasteners fabricated from a rigid material such as plastic, are secured via first ends 38 and 52 to the transport member 12 at predetermined positions, preferably upon long portions 32 of respective first and second outer straps 26 and 28. One or more closing members for tightly securing the transport member 12 about the carcass 8 are comprised of first and second straps 70 and 82 fabricated from non-deformable material, and fasteners fabricated from a rigid material such as plastic, are secured via first ends 72 and 84 to the transport member at predetermined positions, preferably upon short portions 34 of respective first and second outer straps 26 and 28. The carcass 8, generally a deer, is disposed upon the transport member as depicted in FIG. 5, whereupon, first and second fastener portions 46 and 60 are coupled together, and the first straps 36 cinched tight about predetermined portions of the deer by pulling the second ends 42 of the first straps 36 (see FIGS. 1 and 6-8). The transport member 12 is wrapped about the carcass 8 via overlapping first and second edges 40 and 54, whereupon, first and second fastener portions 78 and 90 are coupled together, and the first straps 70 cinched tight about predetermined portions of the deer by pulling the second ends 74 of the first straps 70 (see FIGS. 1 and 9-11).

In the event that adjustable securing means are required for any of the carcass and/or closing members 20 and 22, first ends 38 and 52 of first and second straps 36 and 50 are permanently joined to first adhesive members 106, and/or first ends 72 and 84 of first and second straps 70 and 82 are permanently joined to first adhesive members 106. Second adhesive members 108 are permanently joined to preselected portions of the transport member 12, preferably upon the long portions 32 of the first and second outer straps 26 and 28, and/or the short portions 34 of the first and second outer straps 26 and 28. The first adhesive members 106 with the corresponding straps attached thereto, are then disposed upon the selected second adhesive members 108 such that the deer carcass 8 is tightly secured to the transport member 12, and such that the transport member 12 is tightly wrapped about the deer carcass 8.

Referring to FIGS. 5-10, in the event that either carcass 8 is not tightly secured to the transport member 12, or the transport member 12 is not tightly wrapped about the carcass 8, a person opens the transport member 12, separates selected first adhesive members 106 from second adhesive members 108 by pulling on the grasping member 110 thereby “peeling” the first member 106 from the second member 108, re-positions the first adhesive member 106 upon the second adhesive member 108, re-cinches first straps 36 about the carcass 8, and re-cinches first straps 70 about the transport member 12 to tightly encase the carcass 8 thereby allowing a person the pull the device 100 and the carcass therein 8 over varying terrain.

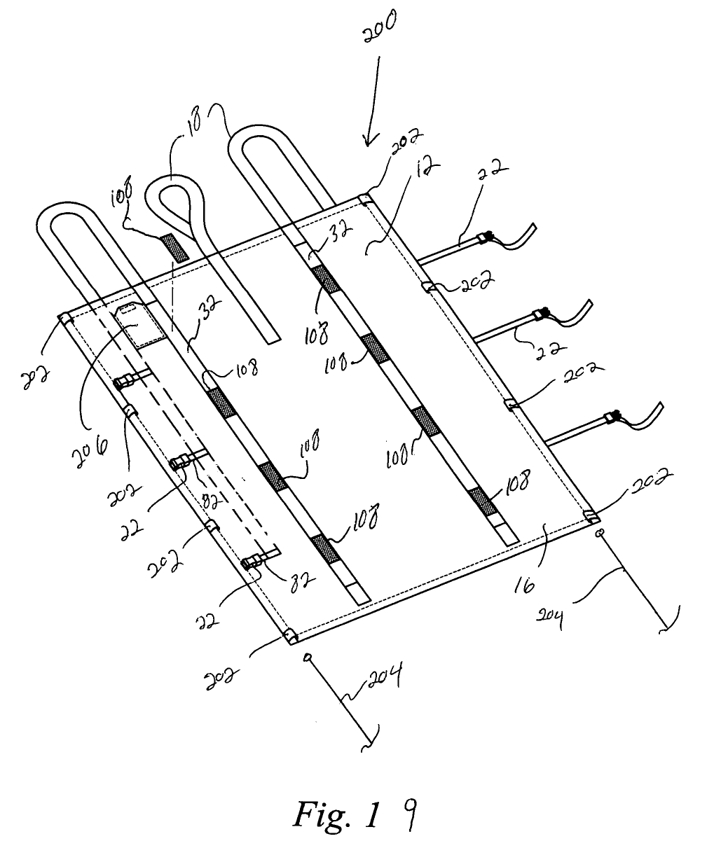

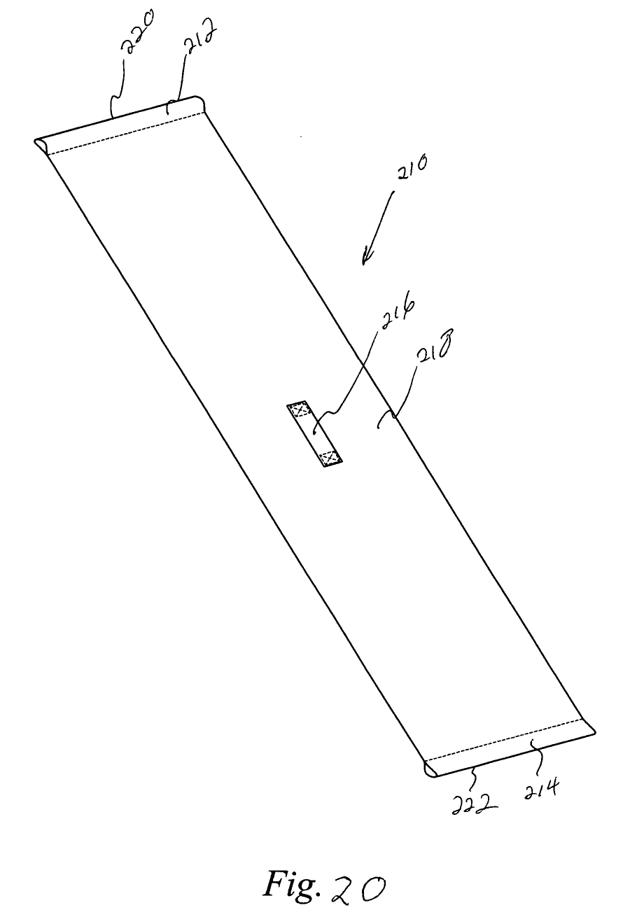

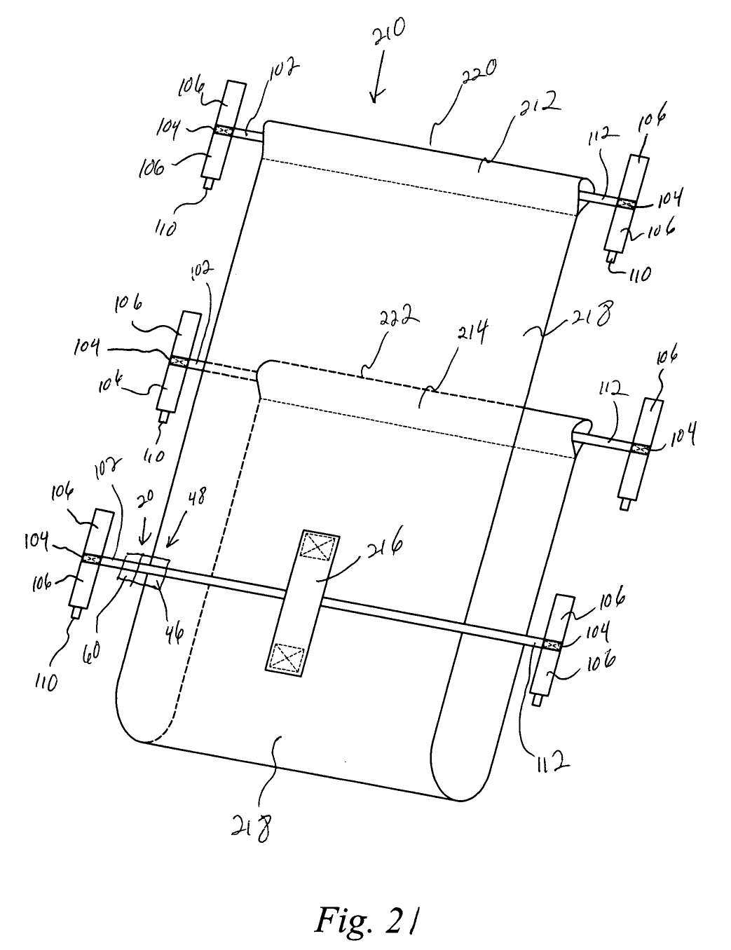

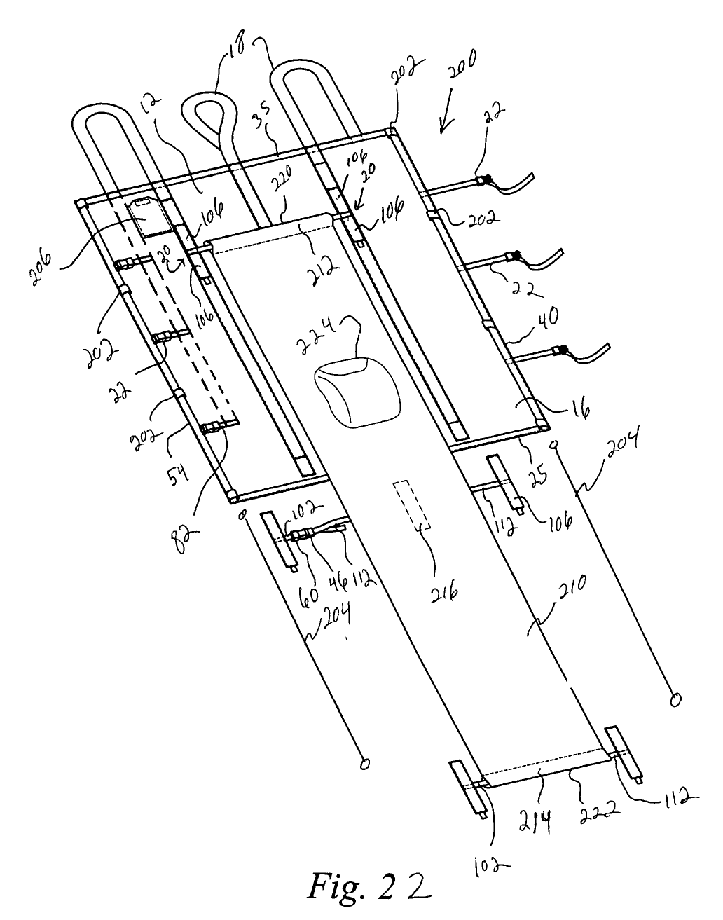

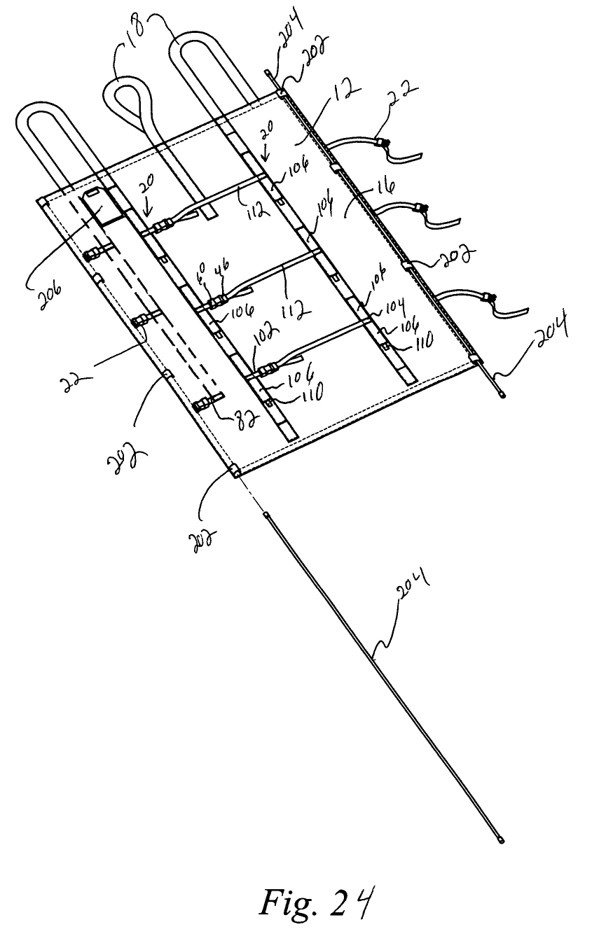

A modification of the above device 10 for manually transporting a carcass 8 in accordance with the present invention is depicted in FIGS. 18-25 and denoted as numeral 200. The modified device 200 allows a hunter to dispose a transport member 12 to manually transport a carcass 8 or to manually carry an injured person to a selected location for medical attention. The modified device 200 includes a transport member 12 having a ground engagement side 14 and a carcass engagement side 16; at least one hauling member 18 for manually hauling the transport member 12 with a carcass 8 therein, the hauling member being secured to the transport member 12; at least one carcass member 20 for securing the carcass 8 to the transport member 12, the carcass member 20 being secured to the transport member 12; means for securing the transport member 12 about the carcass 8; and stretcher members 202 for removably receiving lifting members 204, the stretcher members 202 being secured to the transport member 12 such that the transport member 12 and the lifting 204 members cooperate to elevate and support an injured person (not depicted) disposed upon the transport member 12, whereby the transport member 12 is ultimately disposed to manually transport a carcass or to manually carry an injured person to a selected location.

The transport member 12, hauling member 18 and carcass member 20 of the aforementioned device 10 are incorporated into the modified device 200. The closing member 22 included in the above device 10 may be utilized to encase the carcass 8 in the modified device 200. Alternatively, at least one strap (not depicted) not secured to the transport member 12, is cinched about the transport member 12 which has been wrapped about a carcass 8. Similar cinching features not secured to the transport member 12, may be selected for securing the transport member 12 about the carcass 8 for both the above device 10 and the modified device 200. Alternatively, a first adhesive member (not depicted) secured to a first edge portion of a carcass engagement side 16 of the transport member 12, and a second adhesive member (not depicted) secured to a second edge portion of a ground side 14 of the transport member 12, may be used to secure the transport member 12 about the carcass 8 for both devices 10 and 200. The first and second adhesive members may be fabricated from Velcro hooks and loops, or may be fabricated from materials having comparable grasping features. Replacing the closing member 22 with a cinching strap, promotes the use of the transport member as a stretcher by removing closing members 22 that could become entangled with bushes or other ground obstacles.

The stretcher members 202 include a plurality of polypropylene strips or similar material formed into loops and secured to edge portions 40 and 54 of the transport member 12 via stitching or similar techniques well known to those of ordinary skill in the art. The stretcher members 202 removably receive respective lifting members 204 therethrough. The stretcher members 202 and lifting members 204 cooperate with the transport member 12 to manually lift and carry the transport member 12 with a person thereupon. Alternatively, the loops may be replaced by longitudinal “tubes” (not depicted) extending the length of first and second edges 40 and 54 of the transport member 12. Tubes would distribute an injured person's weight more uniformly across the transport member 12, resulting in more comfort to the injured person, however, the individuals carrying the injured person would have difficulty grasping the lifting member 204 at the edges 40 and 54. “Handles” would have to be added to the first and second edges 40 and 54 when using tubes instead of loops to promote the lifting and carrying of the transport member 12 from the edges 40 and 54.

The lifting members 204 include two collapsible fiberglass rods carried by hunters, or tree limbs cut in the field by the hunters and trimmed to insert into the stretcher members 202. Two lifting members 204 are preferred to promote the lifting and carrying of the transport member 12 with an injured person thereon. The two lifting members provide added strength and allow the transport member 12 to be lifted by two individuals from rear and front ends 25 and 35, and further allow added individuals to lift the transport member 12 from first and second transport member 12 edges 40 and 54 by grasping the lifting members 204 between adjacent stretcher members 202. The carcass members 20 comfortably secure the injured person upon the transport member 12, thereby preventing the injured person from falling from the transport member 12 when being carried over undulating terrain.

Alternatively, one lifting member 204 may be used to lift and carry an injured person. Obviously, the one lifting member 204 would have to be capable of supporting the entire weight of the injured person. Further, all stretcher members 202 secured to the first and second edges 40 and 54 of the transport member 12, would removably receive the one lifting member 204, resulting in the transport member 12 encasing the injured person and obstructing added individuals from lifting the transport member 12 via the first and second edges 40 and 54 disposed vertically above the encased injured person.

The transport member 12 includes a pocket 206 with reflective rescue tabs 208 therein. The rescue tabs 208 have a first side with a first adhesive member thereupon for removably securing a rescue tab 208 to a second adhesive member 108 that is secured to the transport member 12. The second adhesive member 108 may be disposed in sections or as a continuous strip joined to long portions 32 of the hauling members 18, thereby providing added adjustability when detachably securing the carcass members 20 to the transport member 12. The rescue tabs 208 have a second side with a light reflective material thereupon to visually attract a rescuer, thereby marking the position of a hunting party requiring assistance while the hunting is covered by the transport member 12 for protection from inclement weather. The transport member 12 may be used as a lean shelter, fly shelter by utilizing stretcher member loops 202, or a weather shield for keeping a body warm and dry by wrapping the transport member 12 about a person.

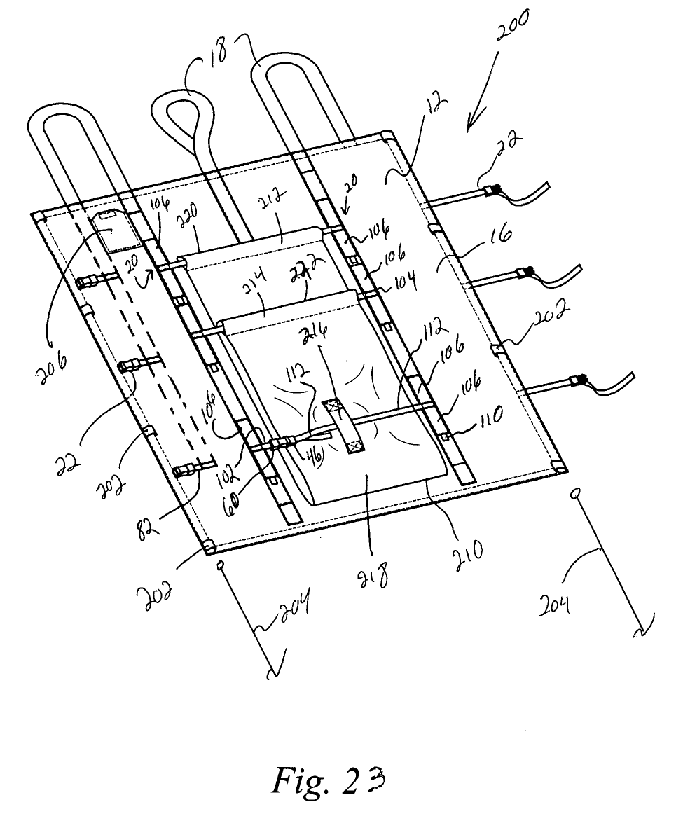

A sling member 210 may be added to the modified device 200. The sling member 210 is fabricated from polypropylene netting and is removably secured to the transport member 12 via the carcass members 20 inserted through upper and lower tubes 212 and 214, and under a strap 216 attached to an outer side 218 of the sling member 210. The tubes 212 and 214 are configured by bending and stitching an edge portion of the upper and lower ends 220 and 222 of the sling member 210. The sling member 210 is ultimately folded about an object 224 (camping supplies or a relatively small carcass), then secured to the transport member 12. The sling member 210 cooperates with the transport member 12 to configure a tube after the transport member 12 has encased both the sling member 210 and the object 224, thereby preventing the object 224 from falling from the modified device 200. The sling member 210 is secured to the transport member 12 by inserting the first strap 112 of a detachable carcass member 20 through the upper and lower tubes 212 and 214, and the strap 216 until the first portions 46 of fastener members 48 are visible. The first portions 46 are then secured to the second portions 60 of the fastener members 48, the second portions 60 being detachably secured to the transport member 12 via second carcass straps 102 joined to first adhesive members 106 which engage second adhesive members 108. The sling member 210 is then configured and disposed as depicted in FIG. 23. Thus, an object 224 or carcass 8 requiring transport by a hunter to or from a hunting area, may be carried or dragged via the transport member 12 without having the object 224 or carcass 8 slide from the rear end 25 of the transport member 12 due to the carcass members 20 and/or closing members 22 becoming loose.

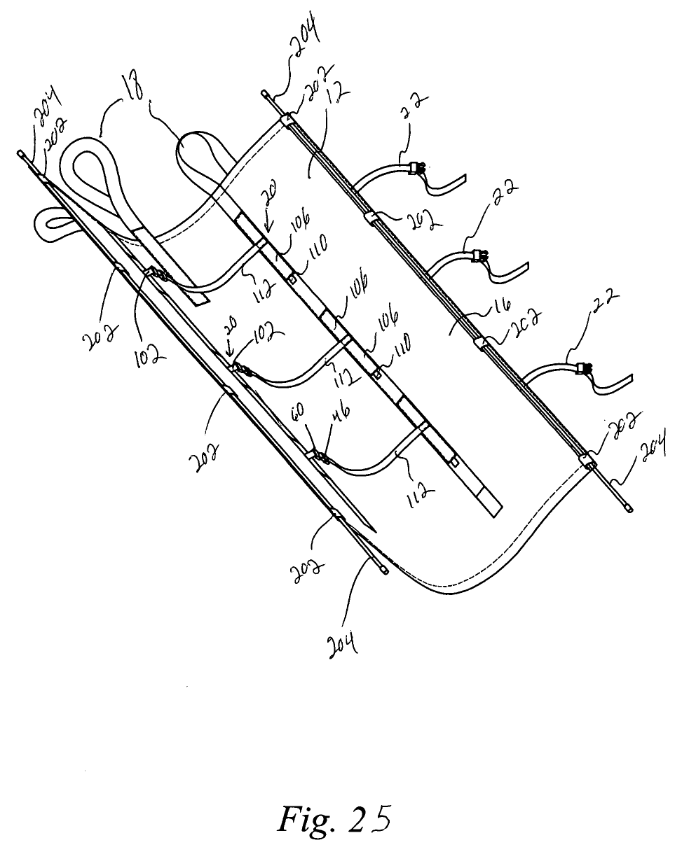

In operation, a modified device 200 for transporting a carcass 8 or injured person is encased in a carrying case 23 and hand carried by one hunter to a hunting site. Upon shooting a relative large game animal (usually a deer), the hunter will encase the carcass 8 in the device 200 using the same procedure as detailed for the original 10 detailed above, then haul the carcass 8 by himself or with the help of other hunters from the field to a selected location. In the event a person is injured in the field and incapable of walking and there are two or more individuals present, the modified device 200 is converted to a stretcher by inserting lifting members 204 through stretcher members 202. The injured person is then placed upon the transport member 12 between the lifting member 204. Hunting party members then lift, via the lifting members 204, rear and front ends 25 and 35 of the transport member 12, and first and second edges 40 and 54 of the transport member 12 if extra hunting party members are available. The injured hunter is then manually carried to a selected location for medical treatment. In the event that the injured hunter is relatively large, the detachable second straps 102 of the carcass members 20 are removed from the transport member 12, and the injured hunter is then secured to the transport member 12 via the first straps 112 of the carcass members 20 snugly engaging the hunter, then being secured to the second straps 82 of the closing members 22 as depicted in FIG. 25.

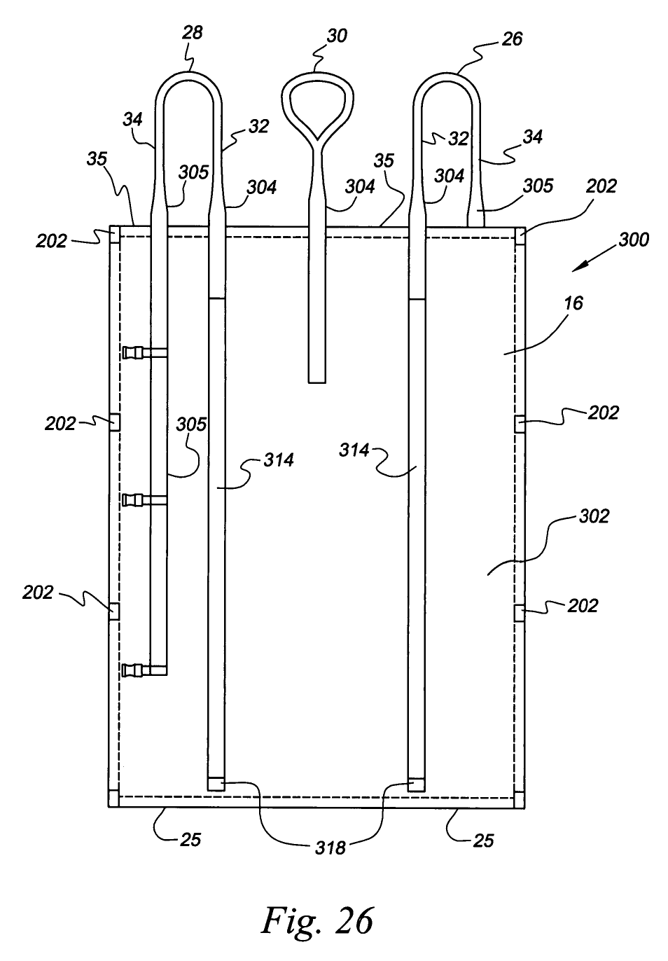

A modification of the modified device 200 for manually transporting an object in accordance with the present invention is depicted in FIGS. 26-33 and denoted as numeral 300. The modified device 300 includes a transport member 302 having substantially the same configuration, dimensions and material of fabrication as the transport member 12 of device 200 described above and depicted in FIGS. 18-25; however, the middle strap 30 and the long portions 32 of the first and second outer straps 26 and 28, include laterally enlarged portions 304 that are attached to the transport member 302. Further, the short portions 34 of the first and second outer straps 26 and 28, include longitudinally and laterally enlarged portions 305 that are attached to the transport member 302.

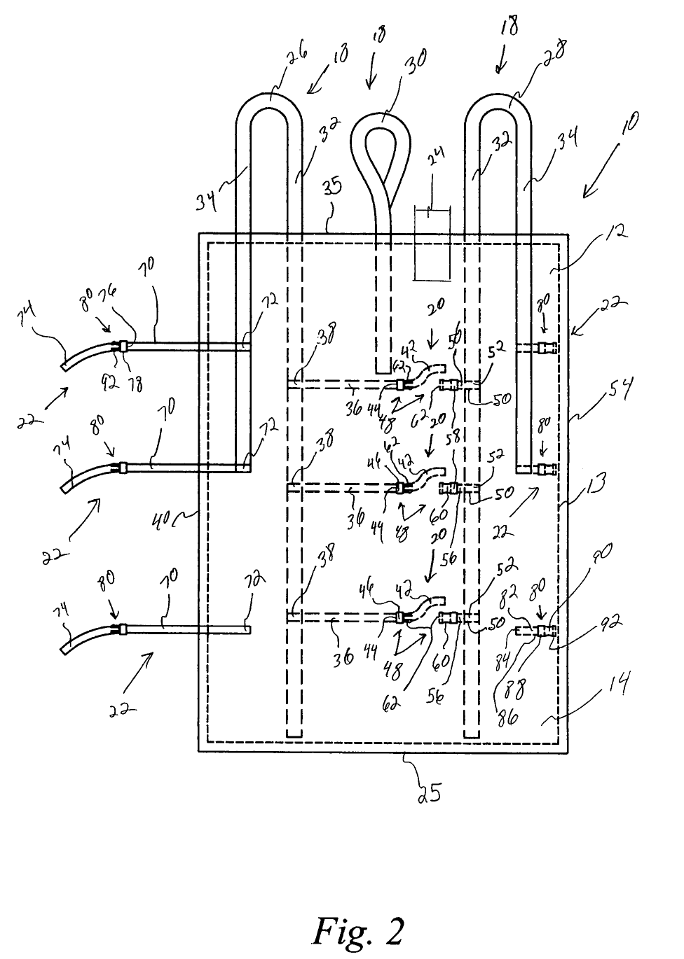

The short portion 32 of the first outer strap 26 of the modified device 300 is attached to the ground engagement side 14 of the transport member 302, and longitudinally lengthened to provide strengthened attachment of the first ends 72 of first webbing straps 70 to the enlarged portion 305 and transport member 302 (see FIGS. 2 and 26). The short portion 34 of the second outer strap 28 of the modified device 300 is attached to the carcass engagement side 16 of the transport member 302, and longitudinally lengthened to provide strengthened attachment of the first ends 84 of the second straps 82 to the enlarged portion 305 and transport member 302. The enlarged portions 304 and 305 engage a corresponding larger area of the transport member 302 to resist the tearing of the long and short portions 32 and 34 of the first and second outer straps 26 and 28 from the transport member 302 when relatively heavy objects are wrapped in and carried by the modified device 300.

The dimensions of the transport member 302 can vary to accommodate a myriad of objects to be carried, including but not limited to animal carcasses, personal property and injured persons. The modified transport member 302 wrapped about an inured person allows the injured person to be “flexibly” carried without using the “stiff” lifting members 204 of modified device 200, thereby promoting the carrying of the injured person over undulating terrain without the risk of the injured person falling from or rolling off the transport member 302 as the persons carrying the transport member 302, bend or otherwise “deform” the transport member as they walk upon an undulating ground surface or navigate stairs or similar inclines.

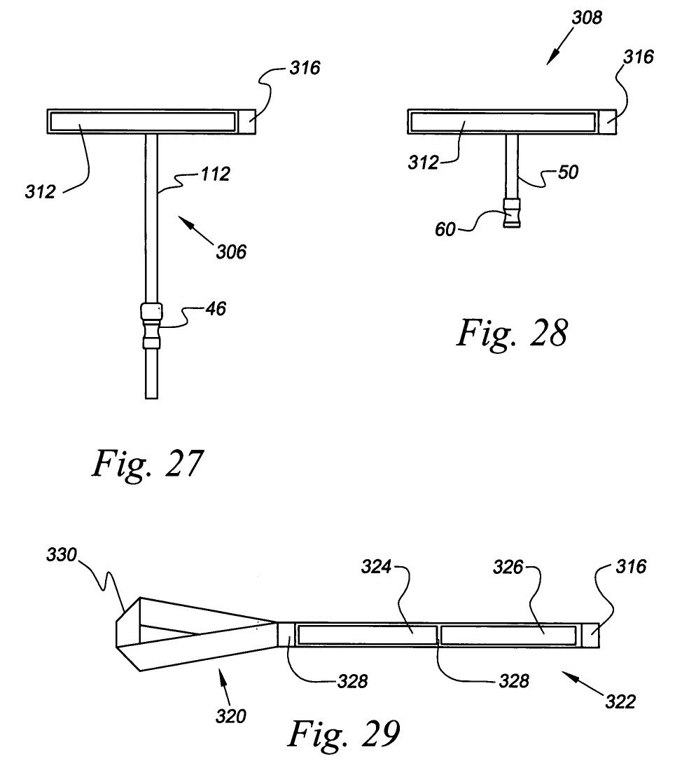

The modified device 300 further includes securing members 306 that are substantially identical to the carcass members 20 of the modified device 200; the varying feature of the securing members 306 being first and second portions 308 and 310 (see FIGS. 27 and 28) with enlarged first adhesive portions 312 that are detachably joined to the cooperating second adhesive portions 314, which are secured to corresponding enlarged portions 304 of the long portions 32. The first and second portions 308 and 310 include grasping members 316 to facilitate the manual removal of the first adhesive portions 312 from the second adhesive portions 314 to readjust the securing members 306 as required. The first and second portions 308 and 310 provide increased grasping strength when the enlarged first adhesive members 312, with hook material 313 secured to bottom surfaces, are manually urged onto a loop material of the second adhesive member 314 which is secured to top surfaces of the long portions 32 of the first and second outer straps 26 and 28.

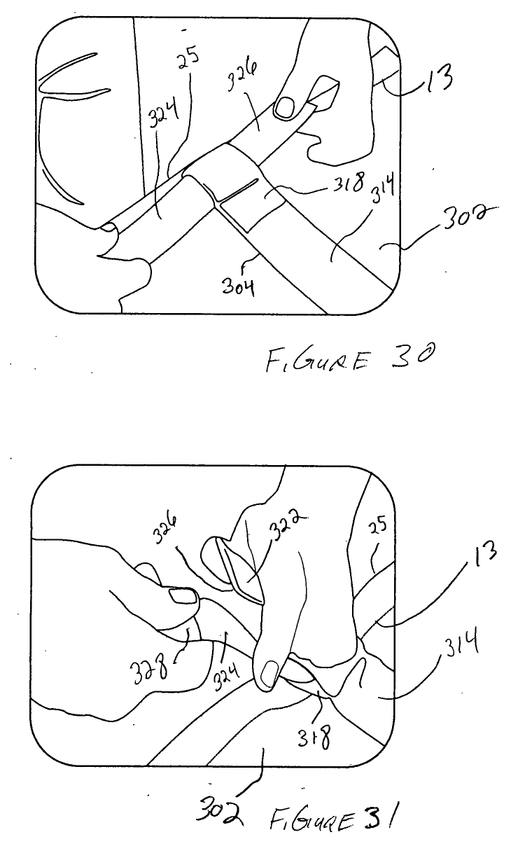

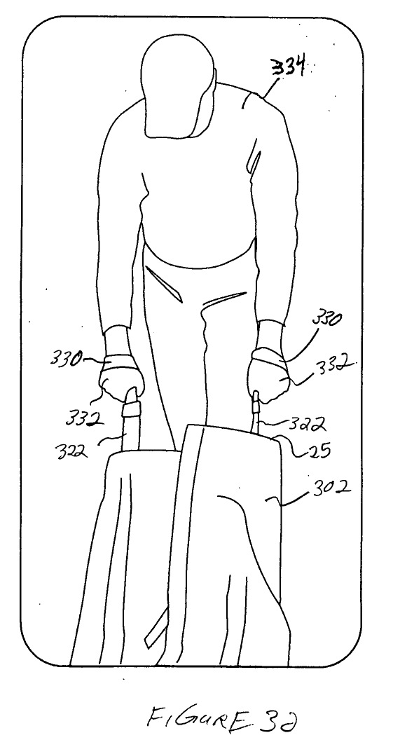

The modified device 300 also includes loop members 318 secured to the rear end 25 of the transport member 302, the loop members 318 being disposed upon the long portions 32 of the first and second outer straps 26 and 28 for prevent tears in the transport member 302 when heavy object are carried. Hand members 320 are ultimately secured to the loop members 318 by manually inserting first portions 322 of the hand members 320 through the loop members 318 (see FIG. 30), then manually folding the first portions 322 (see FIG. 31) such that first (hook material) and second adhesive members (loop material) 324 and 326 secured to a top portion 328 of the hand member 320, are joined together to detachably secure the hand member 320 to the transport member 302. A grasping member 316 is provided to allow a person to manually separate the first and second adhesive members 324 and 326 allow the hand member to be detached from the transport member 302.

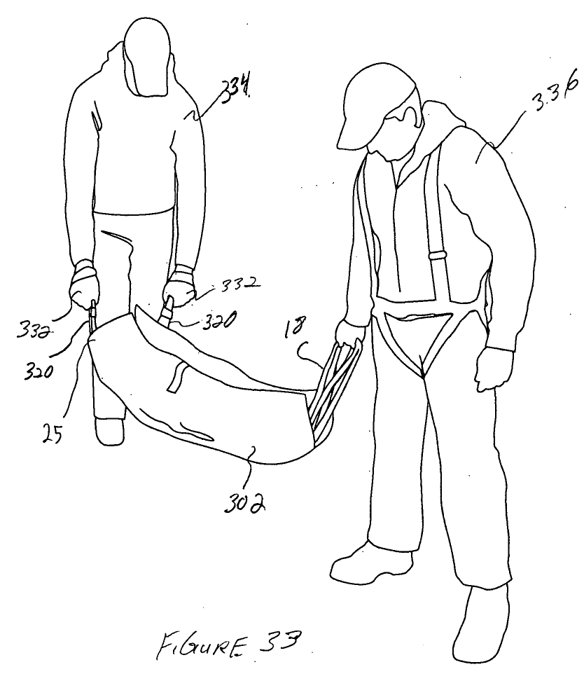

The hand members 320 include a second portion 330 that is ultimately grasped by the hand 332 of a person 334 elevating the rear end 25 of the transport member 302 (see FIG. 32). The person 334 elevates the transport member by wrapping the second portion 330 of the hand member 320 about the wrist and at the same time grasping the second portion 330 via the palm of the hand 332. The transport member 302 and the object wrapped therein is ultimately elevated and carried by one person 336 grasping the hauling member 18 secured to the front end 35 of the transport member 302 (see FIG. 33), and the person 334 grasping the hand members 320 secured to the rear end 25 of the transport member 302 also lifting to elevate the transport member 302, whereupon, the transport member 302 and object are carried by the two persons 334 and 336 to a selected location.

In the event that the injured person being carried is to heavy for two persons to carry, or should the terrain be to steep or congested with debris, such that more than two persons are required to carry the injured person (or object), the transport member 302 can be wrapped about the injured person such that any one or all of the stretcher members 202 can removably receive a hand member 320, thereby allowing as many persons as necessary to elevate and carry the transport member 302 with the injured person wrapped therein.

The foregoing description is for purposes of illustration only and is not intended to limit the scope of protection accorded this invention. The scope of protection is to be measured by the following claims, which should be interpreted as broadly as the inventive contribution permits.

1. A device for manually transporting a carcass comprising:
a transport member;
at least one hauling member for manually hauling said transport member with a carcass therein, said hauling member being secured to said transport member;
at least one carcass member for securing the carcass to said transport member, said carcass member being secured to said transport member; and
at least one closing member for encasing the carcass within said transport member, said closing member being secured to said transport member.

2. The device of claim 1 wherein said transport member includes a ground side and a carcass side.

3. The device of claim 1 wherein said transport member is deformable.

4. The device of claim 2 wherein said ground side includes means for slidably engaging varying ground surfaces such that the transport member is not damaged.

5. The device of claim 2 wherein said carcass side includes means for removing carcass elements from the transport member.

6. The device of claim 1 wherein said transport member includes a pouch secured thereto.

7. The device of claim 1 wherein said hauling member includes a strap longitudinally extending across a substantial portion of said transport member.

8. The device of claim 1 wherein said carcass member comprises:
a first strap having a first end secured to said transport member proximate to a first longitudinal edge of said transport member, said first strap having a second end adjustably secured to a first end of a first portion of a fastener member such that said first portion of said fastener member is slidably positioned across said first ; and
a second strap having a first end secured to said transport member proximate a second longitudinal edge of said transport member, said second strap having a second end secured to a first end of a second portion of said fastener member, said first and second portions of said fastener member having cooperating second ends that detachably join such that a carcass is ultimately secured to said transport member via said second end of said first strap being distally moved from joined second ends of said first and second portions of said fastener member, said second end of said first portion of said fastener member including means for manually releasing said first portion of said fastener member from said second portion of said fastener member thereby allowing said first and second portions to be manually separated to promote the removal of the carcass from said transport member.

9. The device of claim 8 wherein said first end of said first strap is secured to a carcass side of said transport member, said first end being secured a predetermined distance from said first longitudinal edge of said transport member.

10. The device of claim 8 wherein said first end of said second strap is secured to a carcass side of said transport member, said first end being secured a predetermined distance from said second longitudinal edge of said transport member.

11. The device of claim 1 wherein said closing member comprises:
a first strap having a first end secured to said transport member proximate to a first longitudinal edge of said transport member, said first strap having a second end adjustably secured to a first end of a first portion of a fastener member such that said first portion of said fastener member is slidably positioned across said first strap; and
a second strap having a first end secured to said transport member proximate a second longitudinal edge of said transport member, said second strap having a second end secured to a first end of a second portion of said fastener member, said first and second portions of said fastener member having cooperating second ends that detachably join such that a carcass is ultimately encased within said transport member via said second end of said first strap being distally moved from joined second ends of said first and second portions of said fastener member, said second end of said first portion of said fastener member including means for manually releasing said first portion of said fastener member from said second portion of said fastener member thereby allowing said first and second portions to be manually separated to promote the separation of said first and second longitudinal edges of said transport member to expose the carcass secured within.

12. The device of claim 11 wherein said first end of said first strap is secured to a ground side of said transport member, said first end being secured a predetermined distance from said first longitudinal edge of said transport member, said predetermined distance being less than a distance separating a first end of a first strap of said carcass member from said first longitudinal edge of said transport member thereby promoting the wrapping of a first longitudinal edge portion of said transport member about the carcass.

13. The device of claim 11 wherein said first end of said second strap is secured to a carcass side of said transport member, said first end being secured a predetermined distance from said second longitudinal edge of said transport member, said predetermined distance being less than a distance separating a first end of a second strap of said carcass member from said second longitudinal edge of said transport member thereby promoting the wrapping of a second longitudinal edge portion of said transport member about the carcass.

14. The device of claim 1 wherein said transport member is inserted into a carrying bag until being deployed to encase a carcass.

15. The device of claim 1 wherein a plurality of carcass members are included.

16. The device of claim 1 wherein said carcass member is adjustably disposed longitudinally across said transport member.

17. The device of claim 8 wherein said first end of said second strap includes means for adjustably securing said first end of said second strap to said transport member.

18. The device of claim 17 wherein said adjustable securing means includes securing said first end of said second strap to a first adhesive member, and securing a second adhesive member to a portion of said transport member, said first and second portions ultimately being removably joined together such that said second portion of said fastener member is disposed to facilitate the securing of the carcass to said transport member irrespective of the size of the carcass.

19. The device of claim 18 wherein said first adhesive member includes a grasping member to promote the manual separation of said first adhesive member from said second adhesive member thereby facilitating the re-use of said device when varying the size of the carcass to be transported.

20. The device of claim 18 wherein said first adhesive member includes hooks and said second adhesive member includes loops.

21. A hunting device for transporting game comprising:
a carcass encasement member;
means for manually pulling said carcass encasement member with a carcass disposed therein over varying terrain;
means for securing the carcass to one side of the carcass encasement member;
means for promoting the encasement of the carcass by said carcass encasement member; and
means for maintaining said carcass encasement member about the carcass.

22. A method for manually transporting an object, said method comprising the steps of:
providing an encasing member;
providing means for manually pulling said encasing member;
securing said object to said encasing member;
wrapping said encasing member about the object; and
maintaining the wrap position of said encasing member about the object.
